(19) United States
(12) Patent Application Publication
(10) Pub. No.: US 2024/0404245 A1
(43) Pub. Date: Dec. 5, 2024

(54) SIMILAR IMAGE SET CREATING APPARATUS, METHOD AND STORAGE MEDIUM

(71) Applicant: KABUSHIKI KAISHA TOSHIBA, Tokyo (JP)

(72) Inventors: Kouta NAKATA, Chigasaki Kanagawa (JP); Kentaro TAKAGI, Yokohama Kanagawa (JP); Yaling TAO, Kawasaki Kanagawa (JP)

(73) Assignee: KABUSHIKI KAISHA TOSHIBA, Tokyo (JP)

(21) Appl. No.: 18/589,736

(22) Filed: Feb. 28, 2024

(30) Foreign Application Priority Data
May 30, 2023 (JP) 2023-088804

(51) Int. Cl. G06V 10/74; G06V 10/44; G06V 10/762; G06V 10/764

(52) U.S. Cl. CPC G06V 10/761; G06V 10/44; G06V 10/762; G06V 10/764

(57) ABSTRACT

A similar image set creating apparatus includes processing circuitry. The processing circuitry acquires a plurality of images. The processing circuitry extracts first features from the images by using a first model that executes an image classification task. The processing circuitry extracts second features from the images by using a second model that executes an image classification task. The second model is trained in such a manner that mutually similar images in a latent space are continuously distributed, compared to the first model. The processing circuitry selects, from the images, an image of interest serving as a reference of a similar image set, and an auxiliary image similar to the image of interest, based on the first features and the second features.

### CROSS-REFERENCE TO RELATED APPLICATION

This application is based upon and claims the benefit of priority from prior Japanese Patent Application No. 2023-088804, filed May 30, 2023, the entire contents of which are incorporated herein by reference.

### FIELD

Embodiments described herein relate generally to a similar image set creating apparatus, method and storage medium.

### BACKGROUND

In the field of manufacture, efforts have widely been made to monitor the occurrence of a fault or a defect and to improve productivity, by classifying external appearance images of products by machine learning. As a method of classifying external appearance images of products by machine learning, use is made of supervised learning in which teaching labels serving as classification standards are manually added in advance and a classification model is trained by a method such as deep learning. In order to train a high-accuracy classification model, it is necessary to exactly add teaching labels to a large number of images.

In the manufacture, there is a case where it is difficult to exactly add labels by manual work. For example, in a case of adding a label of a good product and a label of a faulty product in regard to a color of an image of a product, a size of a flaw, gloss, or the like, a standard for distinction between a good product and a faulty product is not clear, and there is a possibility that labels are added by workers, based on different standards, or the standard changes during work.

In order to fix the standard for adding labels, samples of images, which are called limit samples, are created. The limit samples clarify the standard for determining labels by indicating examples of a plurality of images serving as samples of good products and faulty products. By adding labels, based on the limit samples, even in a case where a plurality of workers add labels, the work can be performed in accordance with the common standard. Such limit samples are used not only in the label adding work for machine learning, but also in inspections by visual observation, in which machine learning is not used.

While the limit samples fix the standard for the adding of labels and the inspections, there is a tendency that the cost for creating and operating the limit samples is high. In order to create limit samples, it is necessary for an expert of inspections to select samples, the expert having full knowledge of variations of the colors of products, the sizes of flaws, gloss, and the like. In addition, there is a case where the properties of the good product and faulty product vary in accordance with a change of the manufacturing process of products, and the limit samples need to be updated each time. In modern factories, there is a case where products are manufactured by multi-kind and small-quantity production, and a plurality of inspection steps are provided for each product, and therefore a large work cost is incurred for creating and operating limit samples in all inspections.

### BRIEF DESCRIPTION OF THE DRAWINGS

FIG. 1 is a diagram illustrating a configuration example of a similar image set creating apparatus.

FIG. 2 is a diagram exemplarily illustrating inspection images.

FIG. 3 is a diagram exemplarily illustrating a first feature x^{p}_{q}.

FIG. 4 is a diagram illustrating an outline of a first model.

FIG. 5 is a diagram exemplarily illustrating a second feature x^{p}ᵣ.

FIG. 6 is a diagram illustrating an outline of a second model.

FIG. 7 is a diagram schematically illustrating a selection process of images of interest and auxiliary images by a selection unit.

FIG. 8 is a diagram illustrating a processing procedure of a creation process of a limit sample by the similar image set creating apparatus.

FIG. 9 is a diagram illustrating an example of a display screen of representative images of clusters.

FIG. 10 is a diagram illustrating an example of a selection screen of images of interest.

FIG. 11 is a diagram illustrating an example of the selection screen of images of interest.

FIG. 12 is a diagram exemplarily illustrating a first selection method of an auxiliary image.

FIG. 13 is a diagram exemplarily illustrating a second selection method of an auxiliary image.

FIG. 14 is a diagram exemplarily illustrating a display screen of a similar image set.

FIG. 15 is a diagram exemplarily illustrating another display screen of a similar image set.

FIG. 16 is a diagram exemplarily illustrating a display screen of limit samples.

### DETAILED DESCRIPTION

According to one embodiment, a similar image set creating apparatus includes an acquisition unit, a first extraction unit, a second extraction unit, and a selection unit. The acquisition unit acquires a plurality of images. The first extraction unit extracts a plurality of first features from the images by using a first model that executes an image classification task. The second extraction unit extracts a plurality of second features from the images by using a second model that executes an image classification task. Here, the second model is trained in such a manner that mutually similar images in a latent space are continuously distributed, compared to the first model. The selection unit selects, from the images, an image of interest serving as a reference of a similar image set, and an auxiliary image similar to the image of interest, based on the first features and the second features.

Hereinafter, a similar image set creating apparatus, method and storage medium according to the embodiment are described with reference to the accompanying drawings.

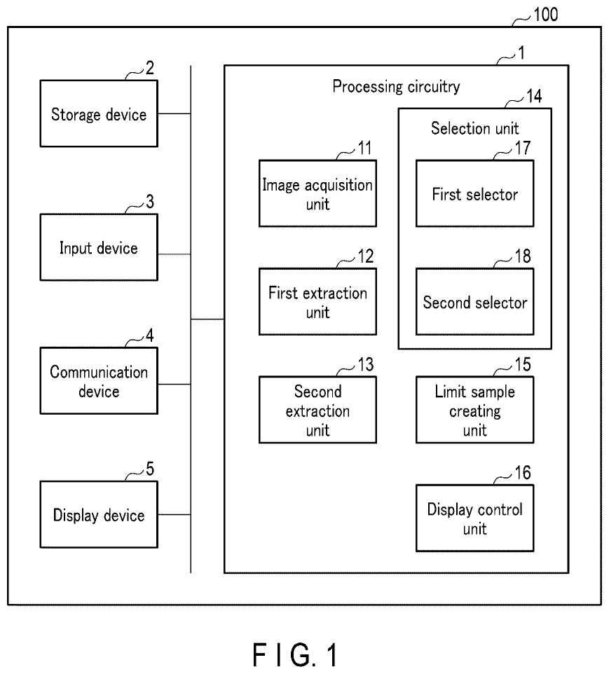

FIG. 1 is a diagram illustrating a configuration example of a similar image set creating apparatus 100 according to the present embodiment. As illustrated in FIG. 1, the similar image set creating apparatus 100 is a computer including processing circuitry 1, a storage device 2, an input device 3, a communication device 4 and a display device 5. Data communication between the processing circuitry 1, storage device 2, input device 3, communication device 4 and display device 5 is executed via a bus or the like.

The processing circuitry 1 includes a processor such as a CPU (Central Processing Unit), and a memory such as a RAM (Random Access Memory). By executing a program, the processing circuitry 1 implements an image acquisition unit 11, a first extraction unit 12, a second extraction unit 13, a selection unit 14, a limit sample creating unit 15 and a display control unit 16. The program is stored in a non-transitory recording medium that is readable by the processor. The program may be stored in a stationary recording medium such as the storage device 2, or may be stored in a portable recording medium. The hardware implementation of the processing circuitry 1 is not limited to the above mode. For example, the hardware may be constituted by a circuit, such as an ASIC (Application Specific Integrated Circuit), which implements the image acquisition unit 11, first extraction unit 12, second extraction unit 13, selection unit 14, limit sample creating unit 15 and display control unit 16. These units 11 to 16 may be implemented by a single integrated circuit, or may be individually implemented by a plurality of integrated circuits.

The image acquisition unit 11 acquires a plurality of images. Inspection objects, which are subjects of images according to the embodiment, are not particularly limited. In addition, photographing equipment of images, conditions for photography, number of pixels, and the like are not particularly limited. The acquired images become candidates of images that form a similar image set, and, by extension, limit samples. For example, in an inspection of a manufacturing process, inspection images including manufactured articles as subjects are acquired. The inspection images may be acquired from photographing equipment provided in various manufacturing processes, or from a computer that stores inspection images generated by the photographing equipment. A normal subject or a faulty subject appears in each of the acquired images. Note that an image, in which a normal subject appears, may not be acquired.

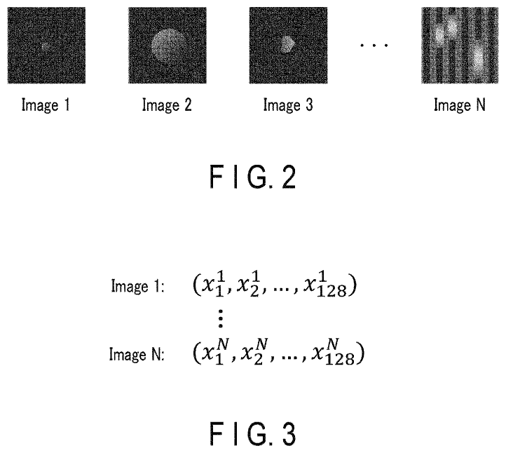

FIG. 2 is a diagram exemplarily illustrating inspection images according to the embodiment. As illustrated in FIG. 2, an N number (N is a natural number of 2 or more) of inspection images are acquired. It is assumed that the inspection images are semiconductor inspection images acquired by photographing semiconductors, which are manufactured in a semiconductor manufacturing factory, by an electron microscope. A normal semiconductor or various faulty semiconductors appear in the inspection images. As defects, as illustrated in FIG. 2, there are defects with various sizes and various shapes. The shapes of defects are various, such as a circle, a polygon, and the like. There is a case where a pattern of a product, such as vertical stripes, appear on the background of the image.

The first extraction unit 12 extracts, from the N images, an N number of first features by using a first model that executes an image classification task. The first model is a deep neural network that transforms an image into a first feature having a lower dimension than the image, and parameters are trained by unsupervised representation learning in such a manner that a distance in a latent space between mutually similar images becomes smaller, and a distance in a latent space between dissimilar images becomes larger. The latent space according to the embodiment is similar in meaning to a space defined by features. The first model is stored in the storage device 2.

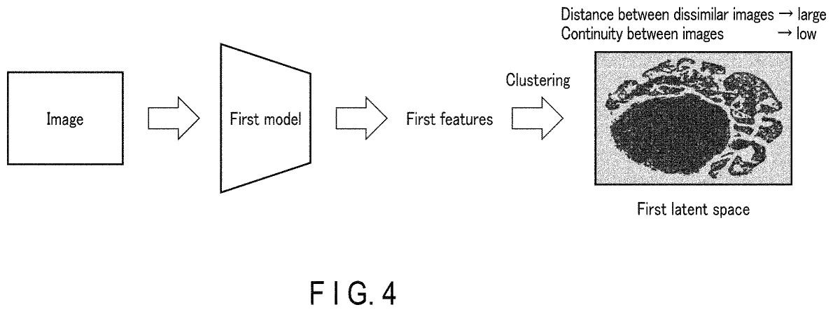

FIG. 3 is a diagram exemplarily illustrating a first feature x^{p}_{q}. The superscript p means a number of an image, and the subscript q means a number of a dimension (element) of the first feature. In the present embodiment, it is assumed that the number of dimensions of the first feature is 128. In this case, a first latent space that is the space of the first feature has 128 dimensions.

In one example, the first model is trained by using a technology of Non Patent Literature 1 (Yaling Tao, Kentaro Takagi, Kouta Nakata. “Clustering Friendly representation learning via instance discrimination and feature decorrelation”, arXiv: 2106.00131 (ICLR2021)). Non Patent Literature 1 proposes a representation learning method that utilizes a deep neural network and extracts features from images without using teaching labels. Specifically, a weight parameter of the first model is trained in such a manner as to minimize a loss function L defined by equation (1) below. As indicated in equation (1), the loss function L is a weighted sum of a loss function L1 and a loss function L2. A balancing parameter λ adjusts an influence degree of the first loss function L1 and an influence degree of the loss function L2 upon the loss function L. The balancing parameter A can be set to a freely chosen value.

$$L = L 1 + λ L 2 \qquad ( 1 )$$

The loss function L1 is a loss function relating to an image classification. The loss function L1 evaluates an error between features of images. Specifically, the loss function L1 is defined by equation (2) below. Here, n means the number of images, with respect to which the loss function L1 is calculated. Subscripts i and j are serial numbers of two kinds of images. In addition, vᵢ is a vector representing an output (first feature) of the first model, which is based on an image i, and vⱼ is a vector representing an output (first feature) of the first model, which is based on an image j. Besides, ti is a first temperature parameter, which adjusts the sensitivity of an inner product between the vectors v. As τ₁ becomes smaller, the sensitivity becomes higher, and as τ₁ becomes greater, the sensitivity becomes lower.

$$L 1 = - {\sum }_{i}^{n} log ( \frac{exp ( {ν}_{i}^{T} {v}_{i} / {τ}_{1} )}{{\sum }_{j = 1}^{n} exp ( {ν}_{j}^{T} {v}_{i} / {τ}_{1} )} ) \qquad ( 2 )$$

The loss function L2 is a loss function relating to a feature decorrelation. The loss function L2 evaluates a correlation between elements of a feature. The loss function L2 is defined by equation (3) below. Here, d means the number of dimensions of the feature, and l and m are serial numbers of the elements of the image. In addition, fₗ is a vector in which 1st elements of an output (first feature) of the first model, which is based on an image 1, are arranged, and fₘ is a vector in which m-th elements of an output (first feature) of the first model, which is based on an image m, are arranged. Besides, τ₂ is a second temperature parameter, which adjusts the sensitivity of an inner product between the vectors f. As τ₂ becomes smaller, the sensitivity becomes higher, and as τ₂ becomes greater, the sensitivity becomes lower. Non Patent Literature 1 discloses a method in which, by using parameters in a certain range, a distance between similar images becomes smaller and a distance between dissimilar images becomes larger, and thereby a model is generated which extracts features in which images are distributed in clusters.

$$L 2 = - {\sum }_{l = 1}^{d} log ( \frac{exp ( {f}_{l}^{T} f / {τ}_{2} )}{{\sum }_{m = 1}^{d} exp ( {f}_{m}^{T} f / {τ}_{2} )} ) . \qquad ( 3 )$$

FIG. 4 is a diagram illustrating an outline of the first model. As illustrated in FIG. 4, the first model inputs images therein and outputs first features. Since the first model is trained based on equation (1), the first model can generate the first model that, compared to a second model, extracts such first features that a distance between similar images becomes smaller and a distance between dissimilar images becomes larger. The first model can extract first features suitable for such clustering that relatively similar images can be classified into an identical cluster and relatively dissimilar images can be classified into different clusters. There is a tendency that the first features have a low continuity of a distribution of images, compared to second features that are the output of the second model.

The second extraction unit 13 extracts, from the N images, an N number of second features by using a second model that executes an image classification task. The second model is a deep neural network that transforms an image into a second feature having a lower dimension than the image, and, like the first model, parameters are trained by unsupervised representation learning in such a manner that a distance in a latent space between similar images becomes smaller, and a distance in a latent space between dissimilar images becomes larger. The second model is stored in the storage device 2.

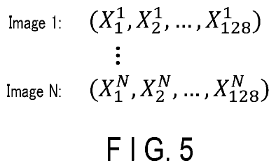

FIG. 5 is a diagram exemplarily illustrating a second feature X^{p}ᵣ. The superscript p means a number of an image, and the subscript r means a number of a dimension (element) of the second feature. In the present embodiment, it is assumed that the number of dimensions of the second feature is 128, like the first feature. In this case, a second latent space that is the space of the second feature has 128 dimensions. Note that the number of dimensions may be different between the second feature and the first feature.

The second model is trained based on a different loss function from the first model. In one example, the second model is trained by using a technology of Non Patent Literature 2 (Wu, Zhirong, et al. “Unsupervised feature learning via non-parametric instance discrimination.” Proceedings of the IEEE conference on computer vision and pattern recognition. 2018). Non Patent Literature 2 proposes a representation learning method that utilizes a deep neural network and extracts features from images without using teaching labels. Specifically, a weight parameter of the second model is trained in such a manner as to minimize a loss function L defined by equation (4) below. As indicated in equation (4), the loss function L for representation learning of the second model is the loss function L1 indicated in equation (1).

$$L = L 1 \qquad ( 4 )$$

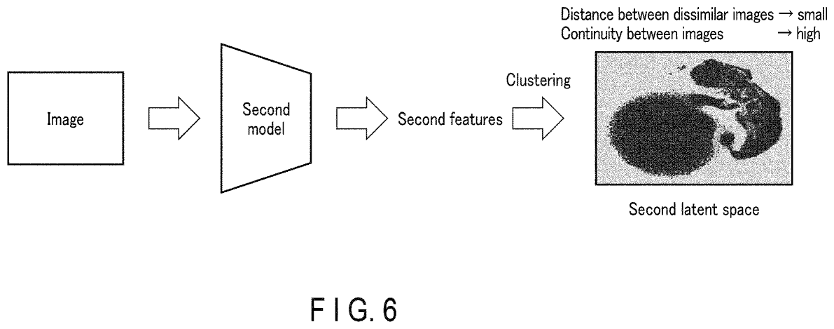

FIG. 6 is a diagram illustrating an outline of the second model. As illustrated in FIG. 6, the second model inputs images therein and outputs second features. Since the second model is trained based on equation (4), it is possible to generate the second model that extracts such second features that a distance between similar images becomes smaller. The second model can extract such second features that a distance between similar images in a second latent space can be made smaller, and the images are continuously distributed in the second latent space. Compared to the first features that are the output of the first model, the second features have such a tendency that the continuity of the distribution of images in the second latent space is high.

As illustrated in FIG. 1, based on the N first features and the N second features, the selection unit 14 selects, from the N images, an image of interest serving as a reference of a similar image set, and an auxiliary image similar to the image of interest. The image of interest and the auxiliary image constitute the similar image set. The number of images of interest may be one or more, and the number of auxiliary images may be one or more. As illustrated in FIG. 1, the selection unit 14 includes a first selector 17 and a second selector 18. Based on the N first features, the first selector 17 selects two or more images of interest from the N images. Based on the N second features, the second selector 18 selects auxiliary images similar to the two or more images of interest from the N images.

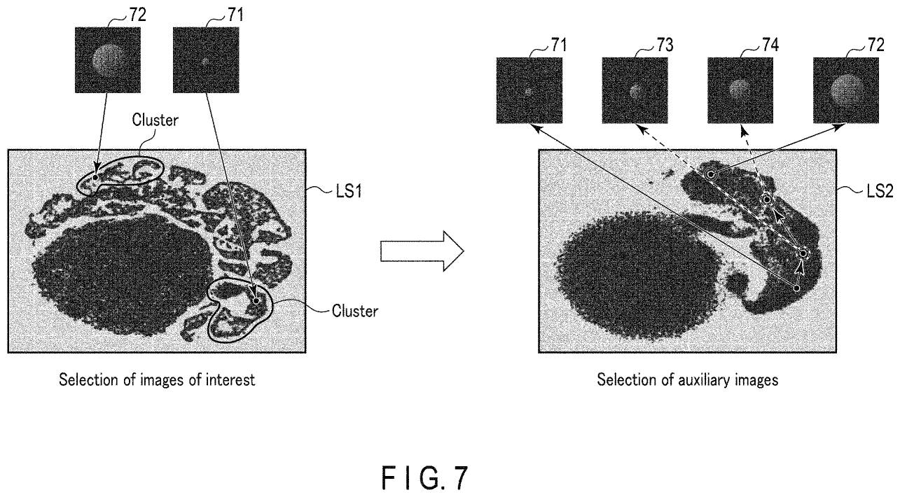

FIG. 7 is a diagram schematically illustrating a selection process of images of interest 71 and 72 and auxiliary images 73, 74 and 75 by the selection unit 14. As illustrated in a left part of FIG. 7, the first selector 17 clusters the N images in a first latent space LS1 by using the first model. As described above, the clustering by the first model has a tendency that a distance between dissimilar images in the first latent space LS1 is large, and the continuity of the distribution of images is low. This means that similar images tends to easily form a cluster. The images belonging to an identical cluster are similar in regard to image features of defects appearing in the images. By confirming a representative image of each cluster, the image features of defects can be confirmed without performing the work of confirming all of the N images. Thus, the first selector 17 selects images of interest 71 and 72 from the representative images of the respective clusters. In FIG. 7, it is assumed that two images of interest are selected.

Next, as illustrated in a right part of FIG. 7, by using the second model, the second selector 18 transforms the N images into features in a second latent space LS2. As described above, the features by the second model has a tendency that a distance between dissimilar images in the second latent space LS2 is small, and the continuity of the distribution of images is high. In the second model, since the N images tend to be continuously distributed in the second latent space LS2, the second model is suitable for automatically selecting auxiliary images in which image features are present between images of interest. In the first model, images in mutually neighboring clusters are not necessarily similar. Thus, the second selector 18 selects, as auxiliary images 73, 74 and 75, images positioned on a path passing through the two images of interest 71 and 72 in the second latent space LS2. Thereby, the auxiliary images 73, 74 and 75, which interpolate the image features of the two images of interest 71 and 72 can be selected. Note that images positioned outside the two images of interest 71 and 72 on the path can also be selected as auxiliary images. Thereby, the auxiliary images extrapolating the image features of the two images of interest 71 and 72 can be selected.

The limit sample creating unit 15 creates a limit sample, based on the images of interest and the auxiliary images selected by the selection unit 14. The limit sample includes an image representing an inspection object positioned at a boundary between a good product and a faulty product. The limit sample may be designated from among the images of interest and the auxiliary images selected by the selection unit 14, or may be created by image processing, based on the images of interest and the auxiliary images.

The display control unit 16 displays various information via the display device 5. For example, the display control unit 16 displays, via the display device 5, an image, an image of interest, an auxiliary image, a similar image set, a limit sample, and the like.

The storage device 2 is constituted by a ROM (Read-Only Memory), an HDD (Hard Disk Drive), an SSD (Solid State Drive), an integrated circuit storage device, or the like. The storage device 2 stores various arithmetic operation results by the processing circuitry 1, various programs executed by the processing circuitry 1, and the like.

The input device 3 inputs various instructions from an operator. As the input device 3, use can be made of a keyboard, a mouse, various switches, a touch pad, a touch-panel display, or the like. An output signal from the input device 3 is supplied to the processing circuitry 1. Note that the input device 3 may be a computer connected to the processing circuitry 1 wiredly or wirelessly.

The communication device 4 is a communication interface for executing information communication with an external device that is connected to the similar image set creating apparatus 100 via a network.

The display device 5 displays various information in accordance with the control by the display control unit 16. As the display device 5, use can be made of, as appropriate, a CRT (Cathode-Ray Tube) display, a liquid crystal display, an organic EL (Electro Luminescence) display, an LED (Light-Emitting Diode) display, a plasma display, or a freely chosen display known in the technical field.

Hereinafter, the details of the similar image set creating apparatus 100 according to the present embodiment are described.

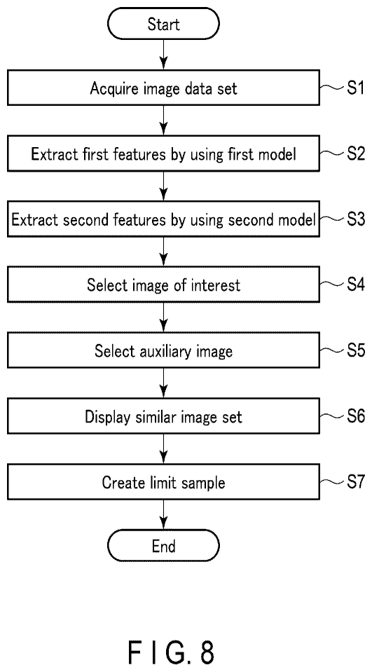

FIG. 8 is a diagram illustrating a processing procedure of a creation process of a limit sample by the similar image set creating apparatus 100. It is assumed that the first model and the second model are generated in advance and stored in the storage device 2.

As illustrated in FIG. 8, to start with, the image acquisition unit 11 acquires an image data set (step S1). It is assumed that the image data set includes an N number of images. To each of the N images, an ID for identifying the image is allocated.

If step S1 is executed, the first extraction unit 12 extracts first features by using the first model (step S2). In step S2, the first extraction unit 12 reads out the first model from the storage device 2, and extracts an N number of first features by applying the first model to the N images. The extracted N first features are stored in the storage device 2. To each of the N first features, an ID of the image, from which the first feature was extracted, is allocated.

If step S2 is executed, the second extraction unit 13 extracts second features by using the second model (step S3). In step S3, the second extraction unit 13 reads out the second model from the storage device 2, and extracts an N number of second features by applying the second model to the N images. The extracted N second features are stored in the storage device 2. To each of the N second features, an ID of the image, from which the second feature was extracted, is allocated.

If step S3 is executed, the first selector 17 selects an image of interest (step S4). In step S4, the first selector 17 classifies the N images into a plurality of clusters, based on the N first features extracted in step S3. Specifically, in the first latent space that is the space of the first features, the first selector 17 plots the first feature of the image with respect to each of the N images. Then, the first selector 17 clusters the N images plotted in the first latent space, by using a general clustering method such as a k-means method. In one example, the first latent space is set in a space having the same number of dimensions as the number of dimensions of the first feature. If the first feature has 128 dimensions, the first latent space is also set to have 128 dimensions. Note that the first selector 17 may form a first latent space that is contracted to two dimensions or three dimensions. The algorithm of the contraction is not particularly limited, but, for example, t-SNE (t-distributed stochastic neighbor embedding) or the like may be used. Next, the first selector 17 selects a plurality of representative images that represent a plurality of clusters. The display control unit 16 causes the display device 5 to display the representative images in such a manner that the representative images are selectable via the input device 3. Then, the first selector 17 selects, as images of interest, representative images that are selected via the input device 3 from among the representative images.

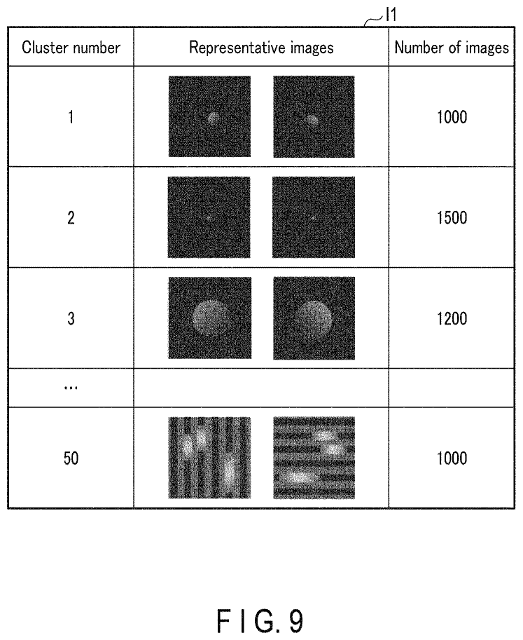

FIG. 9 is a diagram illustrating an example of a display screen I1 of representative images of clusters. As illustrated in FIG. 9, the display screen displays a cluster number, representative images of each cluster, and the number of images belonging to each cluster. In the present embodiment, the number of clusters is set to 50, and the clustering by the first features is executed. As a result of clustering, for example, 1000 images belong to the cluster of number “1”, and two representative images illustrated in a middle column are selected and displayed. As the representative images of each cluster, for example, images near a cluster central feature among the images belonging to each cluster, are selected. The cluster central feature means an average value, a median or some other statistic of the first features of the images belonging to each cluster. In the result of the clustering of FIG. 9, it is understood that circular defects with different sizes are classified into different clusters. Note that the number of representative images of each cluster is not limited to two, and may be one, or three or more. In addition, the number of representative images may vary from cluster to cluster.

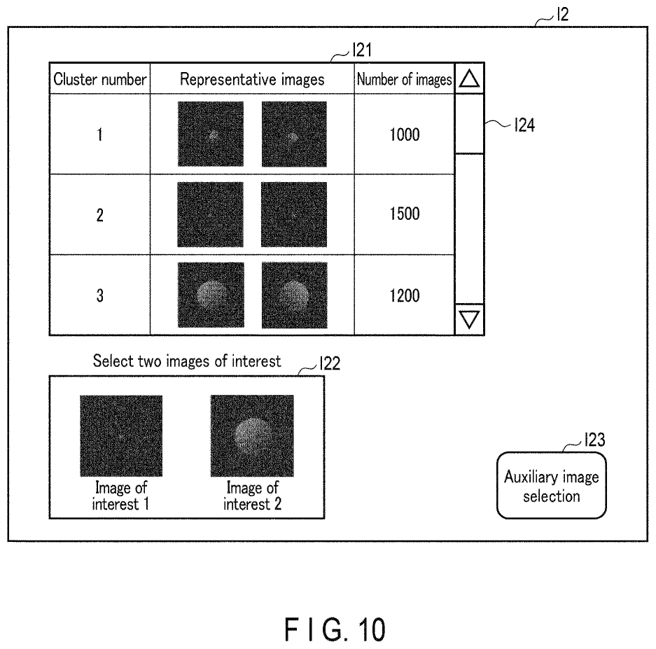

FIG. 10 is a diagram illustrating an example of a selection screen 12 of images of interest. As illustrated in FIG. 10, the selection screen 12 displays a display field I21 of a display screen of representative images, a display field 122 of images of interest, and an auxiliary image selection button 123. The display field 121 displays the display screen of representative images illustrated in FIG. 9 in such a manner that a display range is slidable by a slider bar 124. The display field 122 displays images of interest selected by the user via the input device 3. In FIG. 10, the selection screen 12 for selecting two images of interest is displayed. Various methods can be used as the selection method of images of interest. For example, there is a method in which freely chosen representative images displayed in the display field 121 are clicked. In this case, the clicked representative images are displayed in the display field 122 as images of interest. In another selection method, freely chosen representative images displayed in the display field 121 may be dragged and dropped in the display field 122. In this case, the dragged and dropped representative images are displayed in the display field 122 as images of interest. The images of interest in the display field 122 may be displayed such that the images of interest can be rearranged via the input device 3.

In a case of creating a good product limit sample or a faulty product limit sample, a good product and a faulty product relating to an image feature or a kind of defect, to which the user pays attention may be selected as the two images of interest. For example, in a case where the image feature or the kind of defect, to which the user pays attention, is a size of a defect, an image on which a defect of a size classified as a good product appears, and an image on which a defect of a size classified as a faulty product appears, may be selected. The two images of interest may be selected from different clusters, or may be selected from one cluster. Note that, aside from the image feature or the kind of defect to which the user pays attention, a shape of a defect, color, or gloss, or a background image pattern, or the like, may be used.

If the two images of interest are selected, the auxiliary image selection button 123 is pressed via the input device 3. If the auxiliary image selection button 123 is pressed, an auxiliary image selection process (step S5) is executed.

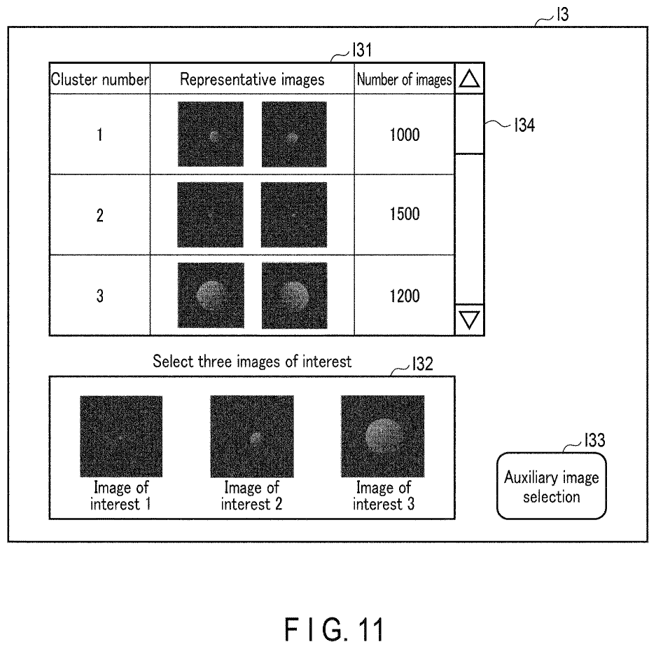

FIG. 11 is a diagram illustrating another example of a selection screen 13 of images of interest. As illustrated in FIG. 11, the selection screen 13 displays a display field 131 of a display screen of representative images, a display field 132 of images of interest, and an auxiliary image selection button 133. The display field 131 and the auxiliary image selection button 133 are identical to the display field I21 and the auxiliary image selection button I23 illustrated in FIG. 10. In the selection screen 13, three images of interest can be selected, and the display field 132 displays three images of interest. In FIG. 11, in one example, three images of interest are selected and displayed in order in accordance with a standard such as the size of a defect. The selection method of images of interest is similar to the selection method illustrated in FIG. 10. Note that the number of images of interest is not limited to two or three, and may be four or more. In addition, the images of interest in the display field 132 may be displayed such that the images of interest can be rearranged via the input device 3.

If step S4 is executed, the second selector 18 selects an auxiliary image (step S5). In step S5, the second selector 18 selects auxiliary images having similar image features to the images of interest selected in step S4, by utilizing continuity of the distribution of similar images in the second latent space. Hereinafter, two kinds of selection methods of auxiliary images are concretely described.

In a first selection method of auxiliary images, the second selector 18 calculates, in the second latent space relating to the N second features, a line passing through the first image of interest and the second image of interest among the two or more images of interest selected in step S4, and selects, as auxiliary images, images having a less distance than a threshold from the line among the N images.

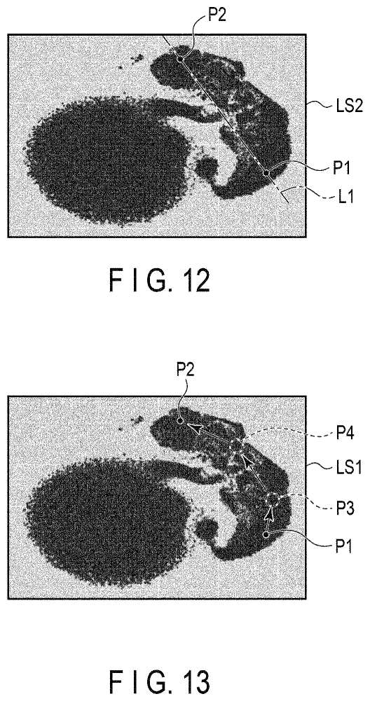

FIG. 12 is a diagram exemplarily illustrating the first selection method of auxiliary images. Specifically, as illustrated in FIG. 12, the second selector 18 plots the second feature of each of the N images in the second latent space LS2 that is the space of the second features. Note that in order to improve the continuity of the image distribution, the second selector 18 may form the second latent space LS2 by contracting the number of dimensions of the second feature to two dimensions or three dimensions. The algorithm of contraction is not particularly limited, but, for example, t-SNE or the like may be used. If the continuity of the image distribution can be secured, a second latent space contracted to four or more dimensions may be used, or a second latent space with no contraction (128-dimensional space) may be used. FIG. 12 exemplarily illustrates the second latent space LS2 of two dimensions.

The second latent space LS2 includes a first image of interest (to be more specific, a second feature of a first image of interest) P1 and a second image of interest (to be more specific, a second feature of a second image of interest) P2, which are selected in step S4. The second selector 18 calculates a straight line L1 passing through the first image of interest P1 and the second image of interest P2. The second selector 18 calculates a distance of each of the second features of the N images in relation to the straight line L1 in the second latent space LS2. Then, the second selector 18 selects images having distances of less than a threshold in the second latent space LS2, as images near the straight line L2. The selected images are set as auxiliary images. The threshold can be set to a freely chosen value. Note that the calculation of the straight line L2 and the calculation of the distance in the second latent space LS2 can be carried out by using general geometrical methods or the like.

By extending the straight line L1 to the outside of the first image of interest P1 and the second image of interest P2, images having defect features extrapolating the image features of the first image of interest P1 and second image of interest P2 can be selected as auxiliary images, in addition to the images having defect features interpolating the image features of the first image of interest P1 and second image of interest P2. Conversely, by restricting the straight line L1 within the inside of the first image of interest P1 and the second image of interest P2, only the images having defect features interpolating the image features of the first image of interest P1 and second image of interest P2 can be selected. In addition, the straight line L1 may be a curve.

In a second selection method of auxiliary images, the second selector 18 selects auxiliary images from among the N images by a path search between the first image of interest and the second image of interest among the two or more images of interest selected in step S4, in the second latent space relating to the N second features.

FIG. 13 is a diagram exemplarily illustrating the second selection method of auxiliary images. As illustrated in FIG. 13, the second features of the N images are plotted in the second latent space LS2. The second latent space LS2 includes the first image of interest P1 and the second image of interest P2 selected in step S4. The second selector 18 sets the first image of interest P1 as a starting point and the second image of interest P2 as an end point, executes a path search by using plots of other images as nodes in the path from the starting point P1 to the end point P2 in the second features, and selects a plurality of auxiliary images having second features between the first image of interest P1 and the second image of interest P2. FIG. 13 illustrates an example in which an image P3 and an image P4 are selected as auxiliary images. A Dijkstra method that is a general method can be used for the path search.

In the selection of auxiliary images by the path search, the number of auxiliary images to be selected can be adjusted, for example, by restricting a one-time movement between nodes in such a manner as to move over a distance of a threshold or more. The threshold of the distance of the one-time movement can be set to a value of a freely chosen quantile point, such as a quartile point, a decile point or a percentile point, of the distance between the nodes, by using the distribution of distances between nodes. In addition, the threshold may be set based on the distance between the second features of the representative images selected by the clustering by the first features.

According to the first and second selection methods, by utilizing a continuous distribution of other images between two images of interest in the second latent space, auxiliary images similar to the two images of interest can efficiently be selected. According to the first selection method, since images at a short distance to the line passing through two images of interest are selected as auxiliary images, auxiliary images can more easily be selected than in the second selection method. According to the second selection method, since auxiliary images are selected by successively selecting images having second features within the threshold distance from the first image of interest (starting point) toward the second image of interest (end point), the auxiliary images can be selected in such a manner that the image features varies in a stepwise manner.

Note that in a case where three or more images of interest are selected, the second selector 18 selects auxiliary images in regard to each of combinations of two images of interest among the three or more images of interest. Thereby, auxiliary images can be selected in the same manner as in the case where the number of images of interest is two. For example, in the case of FIG. 11, auxiliary images can be selected by the above-described first selection method or second selection method, in regard to each of the combination of the image of interest 1 and image of interest 2 and the combination of the image of interest 2 and image of interest 3, the images of interest 1, 2 and 3 being arranged by the user in the order of the size of defects. If necessary, also in regard to the combination of the image of interest 1 and the image of interest 3, auxiliary images may be selected by a similar method.

If step S5 is executed, the display control unit 16 displays a similar image set (step S6). In step S6, the display control unit 16 causes the display device 5 to display, as a similar image set, the images of interest selected in step S4 and the auxiliary images selected in step S5.

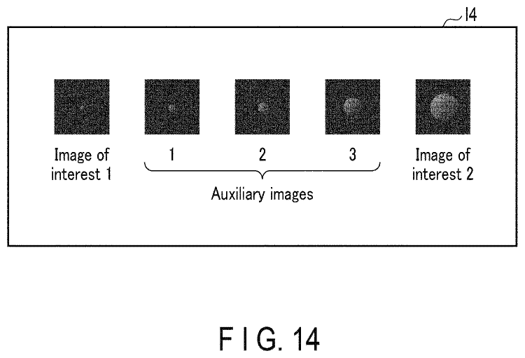

FIG. 14 is a diagram exemplarily illustrating a display screen 14 of a similar image set. FIG. 14 exemplarily illustrates an example in which the image feature, to which attention is paid, is the defect size, and two images of interest are designated. As illustrated in FIG. 14, the display screen 14 displays two images of interest and three auxiliary images as a similar image set. The defect sizes of the three auxiliary images are positioned between the defect sizes of the two images of interest. The two images of interest and the three auxiliary images are arranged in the order of the defect size. By displaying the similar image set formed of the images of interest and auxiliary images, the user can visually recognize the continuity of the image feature such as the defect size. In addition, as the ground for the selection of auxiliary images, the projection image of the second latent space illustrated in FIG. 12 or FIG. 13 may be displayed in the display screen 14. At this time, the plots of auxiliary images in the second latent space may be displayed with visual emphasis by colors, brightness, sizes, or the like. In addition, the plots of images of interest in the second latent space may be displayed with visual emphasis by colors, brightness, sizes, or the like.

In a case where three or more images of interest are selected in step S4, the display control unit 16 causes the display device 5 to display auxiliary images in regard to each of combinations of two images of interest. Specifically, as regards the combinations, the display control unit 16 displays the images of interest and auxiliary images by arranging these images along one axis in regard to the image feature such as the defect size.

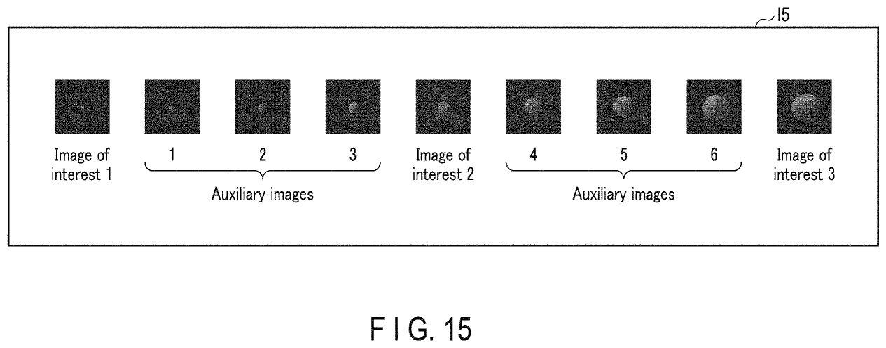

FIG. 15 is a diagram exemplarily illustrating another display screen 15 of the similar image set. FIG. 15 exemplarily illustrates an example in which three images of interest are designated. As illustrated in FIG. 15, the display screen 15 displays three images of interest and six auxiliary images as a similar image set. The defect sizes of three auxiliary images 1, 2 and 3 are positioned between the defect sizes of two images of interest 1 and 2, and the defect sizes of three auxiliary images 4, 5 and 6 are positioned between the defect sizes of the image of interest 2 and image of interest 3. The three images of interest and the six auxiliary images are arranged in the order of the defect size. Thereby, even in the case where three or more images of interest are selected, the user can visually recognize the continuity of the image feature such as the defect size.

Note that the display mode of the similar image set in the case where three or more images of interest are selected is not limited to this. For example, the display control unit 16 may display a plurality of combinations by vertically arranging the combinations, or may display a plurality of combinations in different windows, respectively.

If step S6 is executed, the limit sample creating unit 15 creates a limit sample (step S7). In step S7, the limit sample creating unit 15 creates a limit sample, based on the images of interest selected in step S4 and the auxiliary images selected in step S5. Specifically, the limit sample creating unit 15 selects, from the similar image set illustrated in FIG. 14 or FIG. 15, a limit sample in accordance with the user's instruction via the input device 3. The limit sample may be a good product limit sample that is close to a faulty product, or a faulty product limit sample that is close to a good product, or both of the good product limit sample and the faulty product limit sample. The display control unit 16, in which the limit sample is selected, causes the display device 5 to display a display screen of the limit sample.

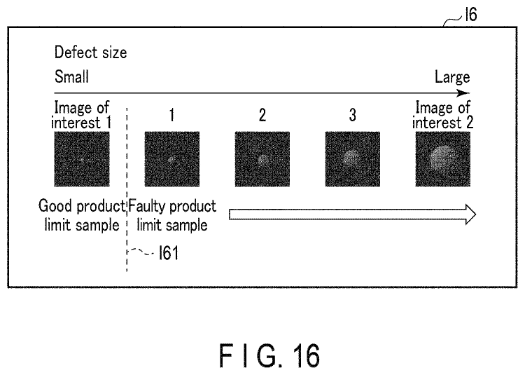

FIG. 16 is a diagram exemplarily illustrating a display screen 16 of limit samples. The display screen 16 of FIG. 16 exemplarily illustrates a case where the image of interest 1 illustrated in FIG. 14 is selected as a good product limit sample, and the auxiliary image 1 is selected as a faulty product limit sample. The display screen 16 displays the similar image set including images of interest and auxiliary images, by explicitly indicating the good product limit sample and/or the faulty product limit sample. Thereby, the user can visually recognize the limit samples in the series of image features such as various defect sizes. At this time, in order to explicitly indicate the good product limit sample and the faulty product limit sample, a label indicating the good product limit sample may be added to the image of interest 1, and a label indicating the faulty product limit sample may be added to the auxiliary image 1. In addition, in order to explicitly indicate a boundary between the good product limit sample and the faulty product limit sample, a mark 161 indicating the boundary may be displayed.

The limit sample may be utilized in a teaching label adding work used for machine learning of a classification model of a fault or defect, or in a visual inspection that does not use machine learning.

By the above, the limit sample creation process is terminated.

Note that the processing procedure of the limit sample creation process illustrated in FIG. 8 is merely an example, and various omissions, additions, and/or modifications can be made without departing from the spirit of the invention.

### (Modification 1)

In the above embodiment, it is assumed that in step S4, two or more images of interest are selected. However, a first selector 17 according to Modification 1 may select one image of interest. Thereby, a decrease of the work for selecting the image of interest, and an increase of variations of the selection of the auxiliary image, can be expected. In this case, for example, the second selector 18 may calculate a freely selected line passing through the image of interest in the second latent space, and may select, as an auxiliary image, an image having a second feature at a distance of less than a threshold from the line, like the first selection method. At this time, for example, the second selector 18 may calculate a line corresponding to the shape of a cluster to which the image of interest belongs. Alternatively, the second selector 18 may select an auxiliary image by a freely selected path search, with the image of interest being used as the starting point.

### (Modification 2)

In the above embodiment, it is assumed that a limit sample is created based on the similar image set, but it is not always necessary to create a limit sample. A similar image set creating apparatus 100 according to Modification 2 does not include the limit sample creating unit 15. In this case, the similar image set creating apparatus 100 may terminate the process illustrated in FIG. 8 without creating a limit sample, at a time point when the similar image set is created (step S5) or displayed (step S6).

### (Modification 3)

In the above embodiment, it is assumed that the first model and the second model are individually and independently generated. However, the present embodiment is not limited to this. A first model and a second model according to Modification 3 may be two models generated by an identical learning method in different learning stages. Specifically, a deep neural network in an initial stage in the learning process of Non Patent Literature 1 may be used as the second model, and a deep neural network in a later stage may be used as the first model. In one example, the initial stage in the learning process means a stage in which the number of times of repetition of a repeating process in parameter optimization of machine learning is less than a threshold, and the later stage means a stage in which the number of times of repetition is the threshold or more. Needless to say, the initial stage and the later stage may be divided based on some other standard.

### Conclusion

As described above, the similar image set creating apparatus 100 according to the present embodiment includes the image acquisition unit 11, first extraction unit 12, second extraction unit 13 and selection unit 14. The image acquisition unit 11 acquires an N number of images. The first extraction unit 12 extracts, from the N images, N first features by using the first model that executes the image classification task. The second extraction unit 13 extracts, from the N images, N second features by using the second model that executes the image classification task. The second model is trained such that the distance between similar images in the latent space becomes smaller than in the first model. Based on the N first features and the N second features, the selection unit 14 selects, from the N images, an image of interest serving as a reference of a similar image set, and an auxiliary image similar to the image of interest.

According to the above configuration, the selection unit 14 can easily select an image of interest, to which a user pays attention, and an auxiliary image having an image feature similar to the image of interest, by utilizing first features in which a distance between similar images in the latent space is small and a distance between dissimilar images is large, that is, first features that are suitable for clustering, and second features in which a distance between similar images in the latent space is small, that is, second features that are suitable for generating a continuous distribution of similar images in the latent space. Specifically, the selection unit 14 selects the image of interest, based on the first features suitable for clustering. Since similar images concentrate in an identical cluster, the user can easily select the image of interest even in a case where the user does not have expertise about images. In addition, the selection unit 14 selects an auxiliary image, based on the second features suitable for generating a continuous distribution of similar images in the latent space. Thereby, for example, an auxiliary image having an image feature between two images of interest can automatically be selected.

Thus, there can be provided a similar image set creating apparatus, method and storage medium, which can reduce the work of creating a similar image set including an image, to which a user pays attention, and an image similar to this image, from among many images.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A similar image set creating apparatus comprising processing circuitry, the processing circuitry being configured to:
acquire a plurality of images;
extract a plurality of first features from the images by using a first model that executes an image classification task;
extract a plurality of second features from the images by using a second model that executes an image classification task, the second model being trained in such a manner that mutually similar images in a latent space are continuously distributed, compared to the first model; and
select, from the images, an image of interest serving as a reference of a similar image set, and an auxiliary image similar to the image of interest, based on the first features and the second features.

2. The similar image set creating apparatus of claim 1, wherein the processing circuitry is configured to:
select two or more of the images of interest from the images, based on the first features; and
select, from the images, the auxiliary images similar to the selected two or more of the images of interest, based on the second features.

3. The similar image set creating apparatus of claim 2, wherein the processing circuitry is configured to classify the images into a plurality of clusters, based on the first features, to select a plurality of representative images that represent the clusters, and to select, as the images of interest, representative images that are selected via an input device from among the representative images.

4. The similar image set creating apparatus of claim 3, wherein the processing circuitry is configured to cause a display device to display the representative images in such a manner that the representative images are selectable via the input device.

5. The similar image set creating apparatus of claim 4, wherein the processing circuitry is configured to display the selected images of interest in such a manner that the selected images of interest are rearrangeable via the input device.

6. The similar image set creating apparatus of claim 2, wherein the processing circuitry is configured to:
calculate, in a latent space relating to the second features, a line passing through a first image and a second image among the two or more of the images of interest; and
select, as the auxiliary images, images having a less distance than a threshold from the line among the images.

7. The similar image set creating apparatus of claim 2, wherein the processing circuitry is configured to select the auxiliary images from the images by a path search between a first image and a second image among the two or more of the images of interest in a latent space relating to the second features.

8. The similar image set creating apparatus of claim 6, wherein the processing circuitry is configured to plot the second features in the latent space that is contracted to two dimensions or three dimensions.

9. The similar image set creating apparatus of claim 7, wherein the processing circuitry is configured to plot the second features in the latent space that is contracted to two dimensions or three dimensions.

10. The similar image set creating apparatus of claim 2, wherein the processing circuitry is configured to select, in a case where three or more images of interest are selected as the two or more of the images of interest, the auxiliary images in regard to each of combinations of two images of interest among the selected three or more images of interest.

11. The similar image set creating apparatus of claim 10, wherein the processing circuitry is configured to cause a display device to display the auxiliary images in regard to each of the combinations of the two images of interest.

12. The similar image set creating apparatus of claim 1, wherein the first model is trained in such a manner that a distance between mutually similar images in a latent space becomes greater than in the second model.

13. The similar image set creating apparatus of claim 1, wherein the first model and the second model are generated by unsupervised representation learning and are trained based on mutually different loss functions.

14. The similar image set creating apparatus of claim 1, wherein the processing circuitry is configured to cause a display device to display the image of interest and the auxiliary image as the similar image set.

15. The similar image set creating apparatus of claim 1, wherein the processing circuitry is configured to create a limit sample, based on the image of interest and the auxiliary image.

16. A similar image set creating method comprising:
acquiring a plurality of images;
extracting a plurality of first features from the images by using a first model that executes an image classification task;
extracting a plurality of second features from the images by using a second model that executes an image classification task, the second model being trained in such a manner that mutually similar images in a latent space are continuously distributed, compared to the first model; and
selecting, from the images, an image of interest serving as a reference of a similar image set, and an auxiliary image similar to the image of interest, based on the first features and the second features.

17. A non-transitory computer readable medium including computer executable instructions, wherein the instructions, when executed by a processor, cause the processor to perform operations comprising:
acquiring a plurality of images;
extracting a plurality of first features from the images by using a first model that executes an image classification task;
extracting a plurality of second features from the images by using a second model that executes an image classification task, the second model being trained in such a manner that mutually similar images in a latent space are continuously distributed, compared to the first model; and
selecting, from the images, an image of interest 10 serving as a reference of a similar image set, and an auxiliary image similar to the image of interest, based on the first features and the second features.
